(19) United States
(12) Patent Application Publication
(10) Pub. No.: US 2023/0195275 A1
(43) Pub. Date: Jun. 22, 2023

(54) SPLIT SCREEN INTERACTION METHOD AND DEVICE, ELECTRONIC APPARATUS AND READABLE STORAGE MEDIUM

(71) Applicant: BOE TECHNOLOGY GROUP CO., LTD., Beijing (CN)

(72) Inventor: Ken WEN, Beijing (CN)

(21) Appl. No.: 17/926,647

(22) PCT Filed: Aug. 4, 2021
(86) PCT No.: PCT/CN2021/110543

§ 371 Date: Nov. 21, 2022

(30) Foreign Application Priority Data
Sep. 30, 2020 (CN) 202011066356.7

(51) Int. Cl. G06F 3/0481; G06F 3/0488; G06F 3/0482

(52) U.S. Cl. CPC G06F 3/0481; G06F 3/0482; G06F 3/0488; G06F 2203/04803

(57) ABSTRACT

A split screen interaction method and apparatus, an electronic device and a computer-readable storage medium. The method comprises: in response to a user operation, controlling a display to display a first interface and a second interface in a split-screen mode, wherein the first interface displays a list of a plurality of destinations, and wherein the second interface displays a map interface; in response to a user operation on the plurality of destinations, controlling the map interface to display routes from a user’s current location to each of the plurality of destinations and a plurality of icons corresponding to the plurality of destinations; and in response to a user operation on at least one of the plurality of icons, controlling the first interface to adjust display content.

### CROSS REFERENCE TO RELATED APPLICATION

The present application claims priority to Chinese patent application No. 202011066356.7, filed on Sep. 30, 2020, the entire contents of which are incorporated herein by reference.

### TECHNICAL FIELD

The present disclosure relates to the field of image technology, and in particular, to a split screen interaction method, a split screen interaction device, an electronic apparatus, and a non-transitory computer-readable storage medium.

### BACKGROUND

At present, due to the increasing number of applications, users have an increasingly urgent need to use multiple applications on the same screen at the same time. However, the current split screen operation only achieves the function of displaying multiple sub-screens, and users need to separately operate the split multiple sub-screens to use the multiple applications, resulting in a complicated operation and poor user experience.

### SUMMARY

Embodiments of the present disclosure provide a split screen interaction method, a split screen interaction device, an electronic apparatus, and a non-transitory computer-readable storage medium.

An embodiment of the present disclosure provides a split screen interaction method for a terminal, the terminal including a display, and the split screen interaction method includes: controlling the display to display a first interface and a second interface in a split screen mode in response to an operation of a user on the display, wherein the first interface displays a list of a plurality of destinations, and the second interface displays a map interface; controlling the map interface to display routes from a current location of the user to each of the plurality of destinations respectively and a plurality of icons corresponding to the plurality of destinations in response to a selection operation of the user on the plurality of destinations; and controlling the first interface to adjust a display content in response to a touch operation of the user on at least one of the plurality of icons.

A split screen interaction method in an embodiment of the present disclosure includes displaying a first interface and a second interface in response to a first operation of a user; and controlling, in response to a selection operation of the user on at least one of a first object and a second object in the first interface, the second interface to display a first content associated with an object selected by the user.

A split screen interaction device in an embodiment of the present disclosure includes: a first control module configured to control a first interface and a second interface to display in response to a first operation of a user; and a second control module configured to control, in response to a selection operation of the user on at least one of a first object and a second object in the first interface, the second interface to display a first content associated with an object selected by the user.

An electronic apparatus in an embodiment of the present disclosure includes a processor and a display, wherein the processor is configured to: control the display to display a first interface and a second interface in response to a first operation of a user, and control, in response to a selection operation of the user on at least one of a first object and a second object in the first interface, the second interface to display a first content associated with an object selected by the user.

A non-transitory computer-readable storage medium stored therein with a computer program in an embodiment of the present disclosure, when executed by a processor, causes the processor to perform the split screen interaction method described above. The split screen interaction method includes displaying a first interface and a second interface in response to a first operation of a user; and controlling, in response to a selection operation of the user on at least one of a first object and a second object in the first interface, the second interface to display a first content associated with an object selected by the user.

In the split screen interaction method, the split screen interaction device, the electronic apparatus, and the non-transitory computer-readable storage medium in the embodiments of the present disclosure, the interactive display of the first interface and the second interface can be realized by displaying a first interface and a second interface in response to a first operation of a user; and controlling, in response to a selection operation of the user on at least one of a first object and a second object in the first interface, the second interface to display a first content associated with the object selected by the user, without operating in the second application independently to obtain the first content, which is easy to operate and conducive to improving the user experience.

Additional aspects and advantages of the present disclosure will be partially given in the following description, become obvious from the following description, or learned from practice in the present disclosure

### BRIEF DESCRIPTION OF DRAWINGS

In order to more clearly illustrate the embodiments of the present disclosure or the technical solutions in the existing art, the drawings used in describing the embodiments or the existing art will be briefly described below, it is obvious that the drawings in the following description are only some embodiments of the present disclosure, and other drawings can be obtained by those skilled in the art without creative efforts.

FIG. 1 is a flowchart showing a split screen interaction method according to some embodiments of the present disclosure.

FIG. 2 is a block diagram showing a split screen interaction device according to some embodiments of the present disclosure.

FIG. 3 is a schematic plan view showing an electronic apparatus according to some embodiments of the present disclosure.

FIG. 4 is a schematic diagram showing a situation in a split screen interaction method according to some embodiments of the present disclosure.

FIG. 5 is a schematic diagram showing a situation in a split screen interaction method according to some embodiments of the present disclosure.

FIG. 6 is a schematic diagram showing a situation in a split screen interaction method according to some embodiments of the present disclosure.

FIG. 7 is a schematic diagram showing a situation in a split screen interaction method according to some embodiments of the present disclosure.

FIG. 8 is a flowchart showing a split screen interaction method in some embodiments of the present disclosure.

FIG. 9 is a schematic diagram showing a situation in a split screen interaction method according to some embodiments of the present disclosure.

FIG. 10 is a schematic diagram showing a situation in a split screen interaction method according to some embodiments of the present disclosure.

FIG. 11 is a schematic diagram showing a situation in a split screen interaction method according to some embodiments of the present disclosure.

FIG. 12 is a schematic diagram showing a situation in a split screen interaction method according to some embodiments of the present disclosure.

FIG. 13 is a flowchart showing a split screen interaction method in some embodiments of the present disclosure.

FIG. 14 is a schematic diagram showing a situation in a split screen interaction method according to some embodiments of the present disclosure.

FIG. 15 is a schematic diagram showing a situation in a split screen interaction method according to some embodiments of the present disclosure.

FIG. 16 is a flowchart showing a split screen interaction method in some embodiments of the present disclosure.

FIG. 17 is a schematic diagram showing a situation in a split screen interaction method according to some embodiments of the present disclosure.

FIG. 18 is a schematic diagram showing a situation in a split screen interaction method according to some embodiments of the present disclosure.

FIG. 19 is a flowchart showing a split screen interaction method according to some embodiments of the present disclosure.

FIG. 20 is a flowchart showing a split screen interaction method according to some embodiments of the present disclosure.

FIG. 21 is a schematic diagram showing a situation in a split screen interaction method according to some embodiments of the present disclosure.

FIG. 22 is a schematic diagram showing a situation in a split screen interaction method according to some embodiments of the present disclosure.

FIG. 23 is a flowchart showing a split screen interaction method according to some embodiments of the present disclosure.

FIG. 24 is a flowchart showing a split screen interaction method according to some embodiments of the present disclosure.

FIG. 25 is a flowchart showing a split screen interaction method according to some embodiments of the present disclosure.

FIG. 26 is a schematic diagram showing a situation in a split screen interaction method according to some embodiments of the present disclosure.

FIG. 27 is a schematic diagram showing a situation in a split screen interaction method according to some embodiments of the present disclosure.

FIG. 28 is a schematic diagram showing a connection between a processor and a computer-readable storage medium according to some embodiments of the present disclosure.

### DETAIL DESCRIPTION OF EMBODIMENTS

Embodiments of the present disclosure will be further described with reference to the drawings. The same or similar reference numbers in the drawings identify the same or similar elements or elements having the same or similar functions throughout. In addition, the embodiments of the present disclosure described below in conjunction with the accompanying drawings are exemplary and are only used for illustrating the embodiments of the present disclosure, and are not to limit the present disclosure.

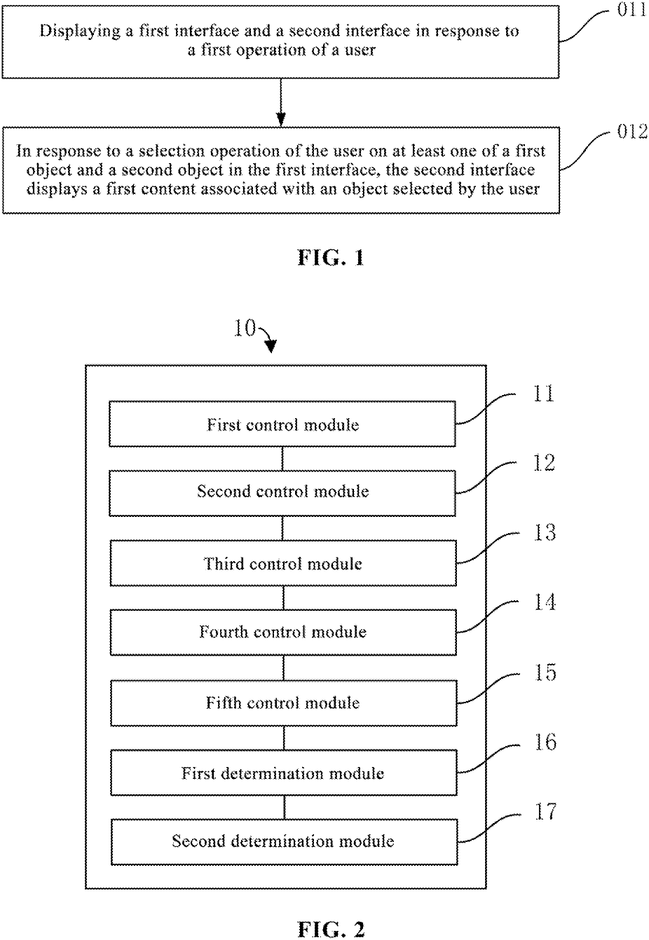

Referring to FIG. 1, a split screen interaction method according to an embodiment of the present disclosure includes steps S011 and S012.

At step 011, a first interface and a second interface are displayed in response to a first operation of a user.

At step 012, in response to a selection operation of the user on at least one of a first object and a second object in the first interface, the second interface displays a first content associated with the selected object by the user.

Referring to FIG. 2, a split screen interaction device 10 according to an embodiment of the present disclosure includes a first control module 11 and a second control module 12. The first control module 11 and the second control module 12 are configured to execute step 011 and step 012, respectively. That is, the first control module 11 is configured to control the display of the first interface and the second interface in response to a first operation of the user. The second control module 12 is configured to control, in response to a selection operation of the user on at least one of the first object and the second object in the first interface, the second interface to display a first content associated with the object selected by the user.

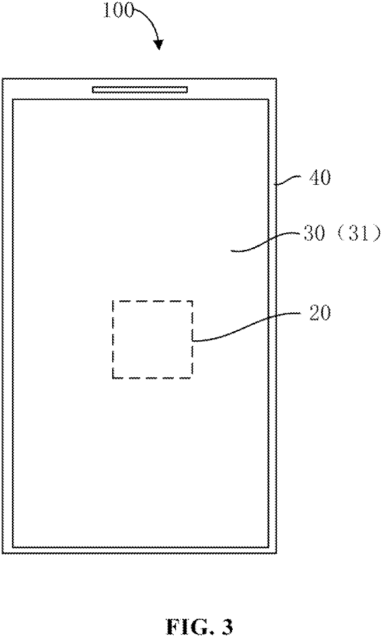

Referring to FIG. 3, in some embodiments, the electronic apparatus 100 includes a display 30 and a processor 20. The processor 20 is configured to control the display 30 to display a first interface and a second interface in response to a first operation of a user; and to control, in response to a selection operation of the user on at least one of a first object and a second object in the first interface, the second interface to display a first content associated with the object selected by the user. That is, step 011 and step 012 can be implemented by the processor 20.

Exemplarily, the electronic apparatus 100 includes a housing 40, the processor 20, and the display 30. The electronic apparatus 100 may be a display device, a cell phone, a tablet computer, a laptop computer, a teller machine, a gate machine, a smart watch, a head-up display device, a game console, etc. As shown in FIG. 3, in an embodiment of the present disclosure, the electronic apparatus 100 is a mobile phone as an example for illustration, and it should be understood that the electronic apparatus 100 is not limited to the mobile phone. Function modules of the electronic apparatus 100, such as a display device (i.e., the display 30), an imaging device, a power supply device, and a communication device may be mounted in the housing 40, so that the housing 40 provides various protections such as dust-proof, anti-falling, and waterproof protections for the function modules.

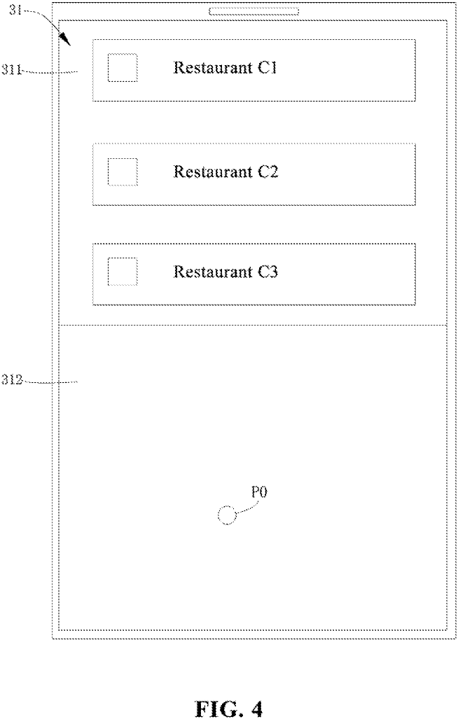

Referring to FIG. 4, the display 30 has a display function and a touch function. The display 30 may receive a first operation from a user, and the processor 20 controls a display interface 31 to display a first interface 311 and a second interface 312 in response to the first operation. The first operation is a split screen interaction operation received by the display 30 from the user, and the split screen interaction operation may be a split screen interaction gesture, for example, a user slides a predetermined gesture (e.g., a “zigzag” track) on the display interface 31 to indicate that the user completes the split screen interaction operation. After the display 30 receives the split screen interaction operation, the processor 20 identifies whether the user has completed the split screen interaction gesture, and controls the display 30 to display the first interface 311 and the second interface 312 after the user has completed the split screen interaction gesture. In an initial state, the display interface 31 of the display 30 displays a whole interface (such as a desktop of a mobile phone, an interface of an application, and the like) which is divided into the first interface 311 and the second interface 312 after the user completes the split screen interaction operation. The first interface 311 and the second interface 312 are at least a part/portion of the display interface 31, for example, the first interface 311 and the second interface 312 constitute the entire display interface 31, or a region obtained by splicing the first interface 311 and the second interface 312 only occupies a part of the display interface 31. In the embodiment, both of the first interface 311 and the second interface 312 constitute the display interface 31. The first operation may also be an operation performed by the user on the electronic apparatus, such as a screen folding operation.

The user may operate the first interface 311 and the second interface 312 separately, so that the first interface 311 displays a desktop of the mobile phone, an interface of an application, a setting interface, a notification bar interface, or the like. For example, the first interface 311 displays a desktop of a mobile phone, and the second interface 312 displays an interface of an application.

The user may also control a display content of the second interface 312 by operating the obj ect in the first interface 311. Exemplarily, the first interface 311 may display an interface of a first application, and the second interface 312 displays an interface of a second application associated with the first application. The first application and the second application may be a catering application, a lifestyle application, a navigation application, a movie application, and the like. The first application and the second application may be different applications. For example, the first application is a lifestyle application (e.g. Dianping which a name of a lifestyle application), and the second application is a navigation application (e.g. map). Alternatively, the first application and the second application may be the same application. For example, both of the first application and the second application are Dianping.

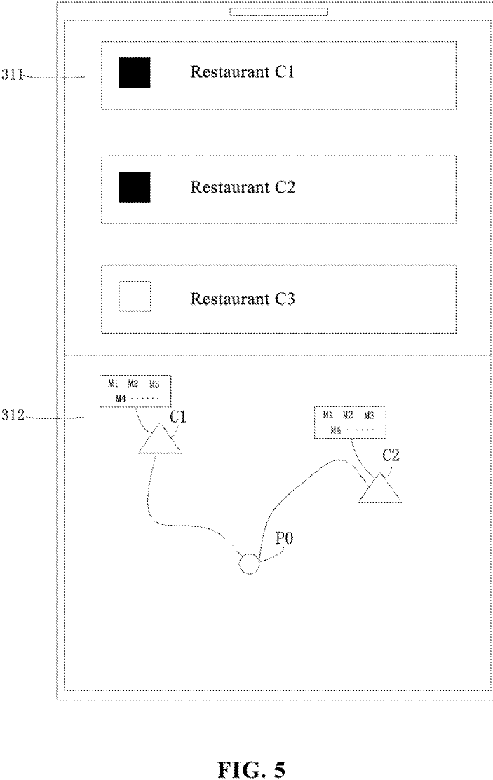

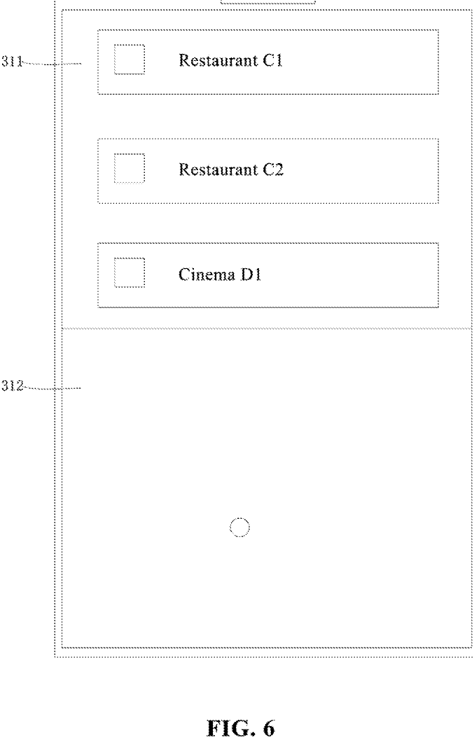

The interface of the application includes a plurality of objects, and for example, in Dianping, a plurality of selectable objects are displayed, as shown in FIG. 4 and FIG. 5. When an interface showing nearby restaurants in Dianping is displayed, the restaurants are displayed one by one; and the processor 20 controls, in response to a selection operation of the user on at least one of the first object and the second object in the first interface 311, the second interface 312 to display a first content associated with the selected object. For example, the first interface 311 displays the interface showing nearby restaurants in Dianping, the second interface 312 displays a navigation interface of a map. In a case where the selected object is a restaurant object, the first content is a route from the current location of the user to the selected restaurant object and an icon corresponding to the restaurant object. For another example, the first interface 311 displays the interface showing nearby restaurants in Dianping, and the second interface 312 displays an interface of a recipe application. In a case where the selected object is a restaurant object, the first content is a plurality of pieces of recipe information corresponding to the special gourmet food of the selected restaurant.

The first object and the second object may have the same attributes, which means that the first object and the second object are the same type of object, such as restaurant objects, scenic spot objects, cinema objects, and the like.

For example, the first interface 311 displays an interface showing nearby restaurants in Dianping, and the second interface 312 displays a navigation interface of a map. The navigation interface of the map may be a navigation interface of a map application built into the system, a navigation interface of third-party map application, or a navigation interface of a map function module embedded in Dianping.

The first interface 311 may display a plurality of restaurant objects, where the first object and the second object are restaurant objects. The user may select at least one of the first object and the second object. When the user selects the first object (e.g., the restaurant C1), the second application displays a navigation route from the current location P0 of the user to the restaurant C1 and an icon corresponding to the restaurant C1 (i.e., the first content at this time is a navigation interface showing a navigation route from the current location P0 to the restaurant C1). Alternatively, when the user selects a second object (e.g., the restaurant C2), the second application displays a navigation route from the current location P0 of the user to the restaurant C2 and an icon corresponding to the restaurant C2 in the map. When the user selects the restaurant C1 at first, the second application displays a navigation route from the current location P0 of the user to the restaurant C1 and the icon corresponding to the restaurant C1 in the map; and subsequently the user selects the restaurant C2, the second application displays the navigation routes from the current location P0 of the user respectively to the restaurant C1 and the restaurant C2 and the icon corresponding to the restaurant C2 in the map, so that the user can simultaneously check the distances from the current location P0 to the restaurant C1 and to the restaurant C2 and select a proper (e.g. closer) restaurant to have a meal. When the user selects the first object and the second object simultaneously, the second application displays the navigation routes from the current location P0 of the user to the restaurant C1 and restaurant C2 and the icons corresponding to the restaurant C1 and the restaurant C2 in the map, as shown in FIG. 5 in detail.

The second application may perform display according to the information of the first application. For example, when the user selects the first object (e.g., the restaurant C1), the second application correspondingly displays a navigation route from the current location P0 of the user to the restaurant C1 and simultaneously displays the information (e.g., whether the restaurant is open M1, score information M2, restaurant type information M3, the gourmet food M4, and the like) about the restaurant C1 in Dianping in the form of a prompt box at a location of the restaurant C1 in the map, so that the user can view the navigation route and view the information of the restaurant, thereby facilitating the user to select a suitable restaurant.

The second interface may be a map interface. The first object and the second object may have different attributes from each other. For example, the first object is a restaurant object, and the second object is a scenic spot object. Alternatively, the first object is a restaurant object, and the second object is a cinema object. Alternatively, the first object is a scenic spot object, and the second object is a cinema object, etc.

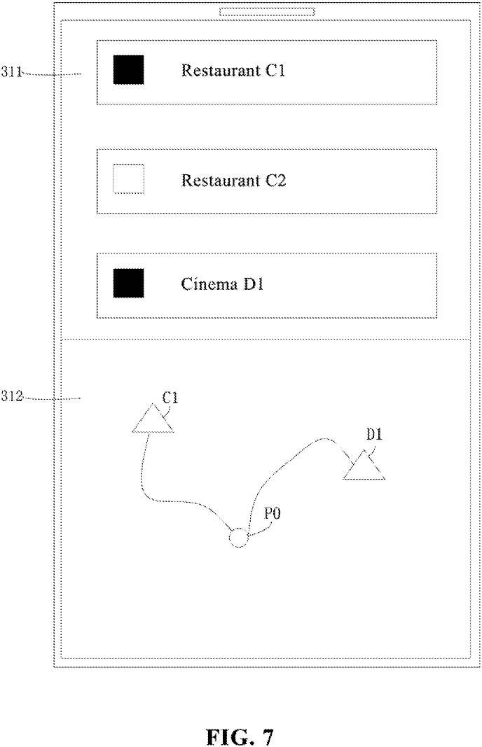

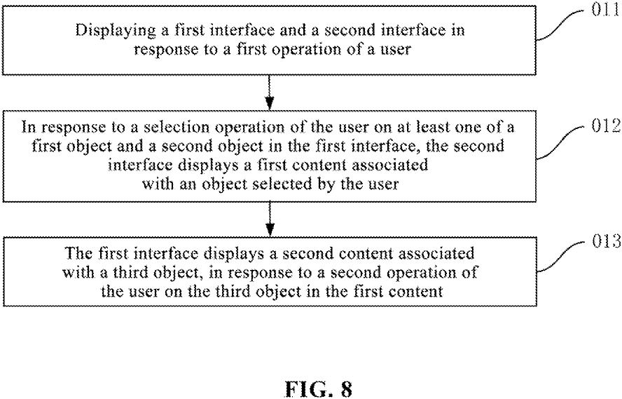

Referring to FIG. 6 and FIG. 7, for example, the first interface 311 displays nearby buildings in Dianping. In this case, the first interface 311 may display a plurality of nearby building objects such as restaurant objects, cinema objects, etc., and the second interface 312 displays a navigation route interface of a map.

At this time, the first object and the second object may be a restaurant object and a cinema object, respectively. Alternatively, the first object and the second object may be a restaurant object and a mall object, respectively. Alternatively, the first object and the second object may be a cinema object and a mall object, respectively. The following description will be illustrated by taking as an example that the first object and the second object are a restaurant object and a cinema object, respectively.

The processor 20 controls, in response to a selection operation of the user on at least one of a restaurant object and a cinema object, the second interface 312 to display a route from the current location P0 of the user to the selected object and an icon corresponding to the selected object. When the user selects the first object (e.g., the restaurant C1), the second application displays the navigation route from the current location P0 of the user to the restaurant C1 correspondingly. When the user selects the second object (e.g., a cinema D1), the second application displays the navigation route from the current location P0 of the user to the cinema D1 correspondingly in the map. When the user selects the restaurant C1 first, the second application displays the navigation route from the current location P0 of the user to the restaurant C1 correspondingly in the map, and subsequently the user selects the cinema D1, the second application displays the navigation routes from the current location P0 of the user to the restaurant C1 and to cinema D1 respectively in the map, so that the user can simultaneously view the distances of the routes from the current location P0 to the restaurant C1 and to the cinema D1 respectively. When the user selects both of the first object and the second object simultaneously, the second application displays the navigation routes from the current location P0 of the user to the restaurant C1 and to the cinema D1 correspondingly in the map. That is, the processor 20 can control the second interface 312 to display the first content associated with the first object and the second object, in response to the selection operation of the user on the first object and the second object, where the first content may be route information from the current location of the user to the first object (i.e., the restaurant C1) and the second object (i.e., the cinema D1). The selection operation may be a click, a long press, a selection gesture, or the like. In the present embodiment, the selection operation is a click on a selection box corresponding to the restaurant object.

It should be noted that the first interface 311 may further include more objects, such as three objects, four objects, nine objects, etc., and the first object and the second object are only used for convenience of description, and the first interface 311 is not limited to include only two objects.

According to the split screen interaction method, the split screen interaction device, the electronic apparatus 100 and the non-transitory computer-readable storage medium in the embodiment of the present disclosure, an interactive display of the first interface 311 and the second interface 312 can be realized by displaying the first interface 311 and the second interface 312 in response to the operation of the user, and controlling, in response to the selection operation on at least one of the first object and the second object of the first interface 311, the second interface 312 to display the first content associated with the selected object, so as to obtain the first content without operating separately in the second application, which is relatively simple in operation and is beneficial to improving the user experience.

Referring to FIG. 8, in some embodiments, the split screen interaction method further includes step 013.

At step 013, in response to a second operation of the user on a third object in the first content, the first interface 311 displays a second content associated with the third object.

Referring again to FIG. 2, in some embodiments, the split screen interaction device 10 further includes a third control module 13. The third control module 13 is configured to execute step 013. That is, the third control module 13 is configured to control the first interface 311 to display the second content associated with the third object, in response to the second operation of the user on the third object in the first content.

Referring again to FIG. 3, in some embodiments, the processor 20 is further configured to control the first interface 311 to display the second content associated with the third object in response to the second operation of the user on the third object in the first content. That is, step 013 can be implemented by the processor 20.

Exemplarily, when the first interface 311 and the second interface 312 are interactively displayed, the processor 20 may not only control the second interface 312 to display, in response to the selection operation of the user on at least one of the first object and the second object of the first interface 311, the first content associated with the selected object, but also further control the first interface 311 to display the second content associated with the third object in response to the second operation of the user on a third object in the first content.

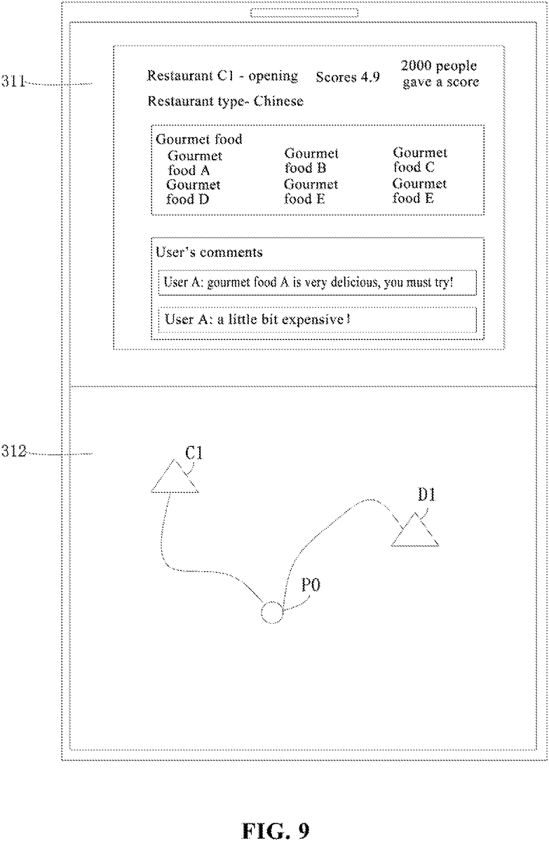

Referring to FIG. 9, for example, the first interface 311 is an interface showing nearby restaurants in Dianping, and the second interface 312 is a navigation interface of a map. After the processor 20 responses to the selection operation of the user on the first object and the second object in the first interface 311, the second interface 312 displays a first content, that is, locations of the restaurant C1 and the restaurant C2 corresponding to the first object and the second object respectively, and navigation routes from the current location P0 of the user to the restaurant C1 and the restaurant C2.

The processor 20 receives a second operation, such as a selection operation, a click operation, etc., of the user on the third object in the first content of the second interface 312. When the user clicks the third object in the first content (e.g., the restaurant C1 near to the user is selected), the interface showing nearby restaurants in Dianping displays specific information about the restaurant C1, such as whether the restaurant C1 is open, score information, the gourmet food, restaurant type information, user’s comments, etc., thereby facilitating the user to obtain the specific information about the restaurant at the target location.

The second operation of the user on the third object in the first content may include determining a first region containing the third object in the second interface 312.

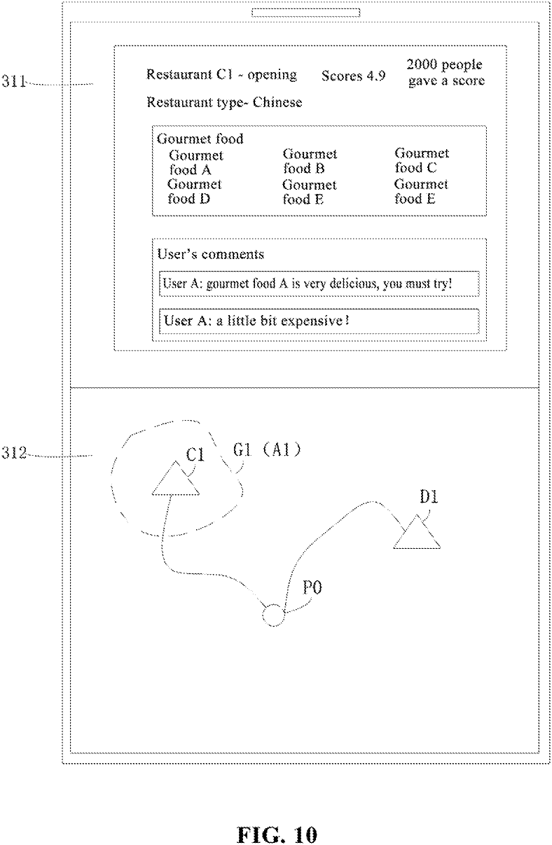

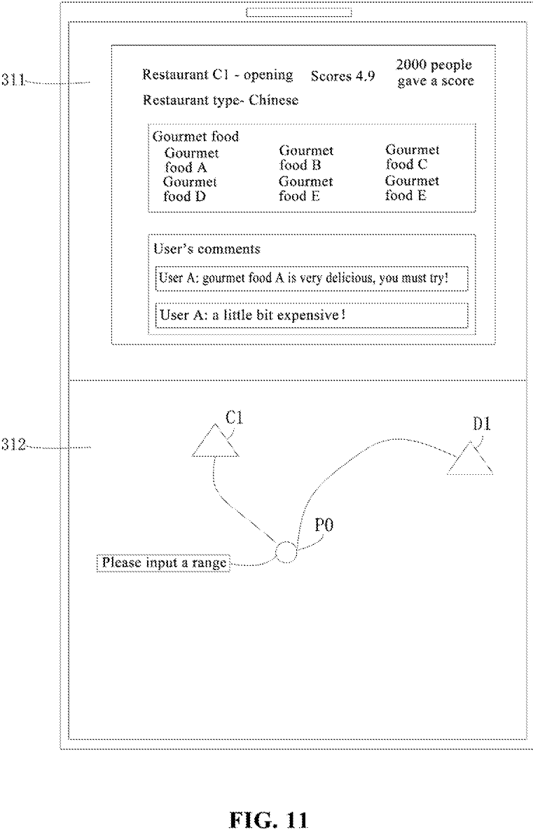

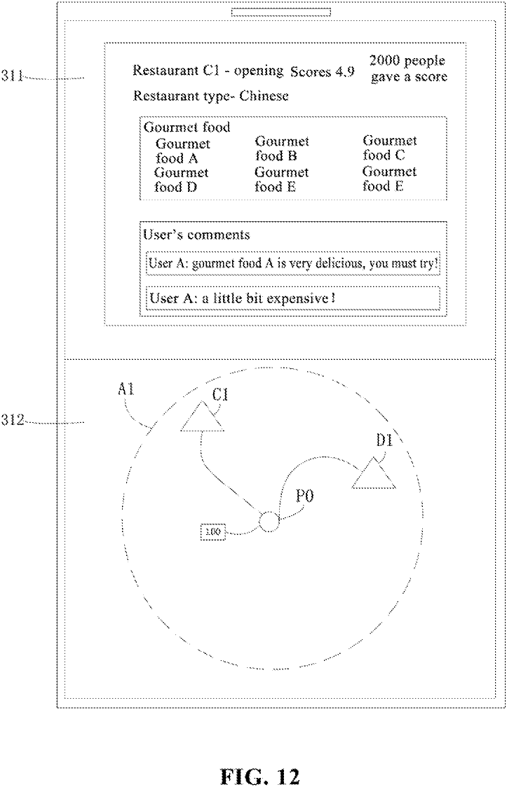

Referring to FIG. 10, the first region A1 is determined according to the touch track of the user. For example, the touch track is a circle drawn in the first content. In a case where the touch track G1 of the user is a circle including the third object (i.e., the restaurant C1), and the region where the circle is located is the first region A1. As shown in FIG. 11 and FIG. 12, the first region A1 may also be determined according to range information input by the user. For example, if the user wants to view information about restaurants within a certain range around the user, the user may click on an object corresponding to the user himself/herself, and input the range information through a pop-up input box. For example, a value of 100 input by the user indicates that a region within a circle having a radius range of 100 meters around the user is the first region A1, thereby allowing the user to more accurately determine the range of the first region A1 centered on the user himself/herself.

In this way, the third object in the first region A1 determined by the user is selected, and the first interface 311 displays the second content corresponding to the third object in the first region A1. For example, the third object in the first region A1 is the restaurant C1, and the second content is information about the restaurant C1.

The processor 20 may also display a fourth object within the first region A1 in response to the operation of determining, by the user, the first region A1 in the second interface 312. The fourth object may have the same attribute as the third object or different attribute from the third object. For example, both of the third object and the fourth object are restaurant objects. Alternatively, the third object is a restaurant object, and the fourth object is a cinema object, or the like. The processor 20 is configured to control the first interface 311 to simultaneously display the second content associated with both of the third object and the fourth object. For example, the third object is a restaurant in the first region A1 and the fourth object is a cinema D1 in the first region A1, and the second content includes information about the restaurant C1 and information about the cinema D1.

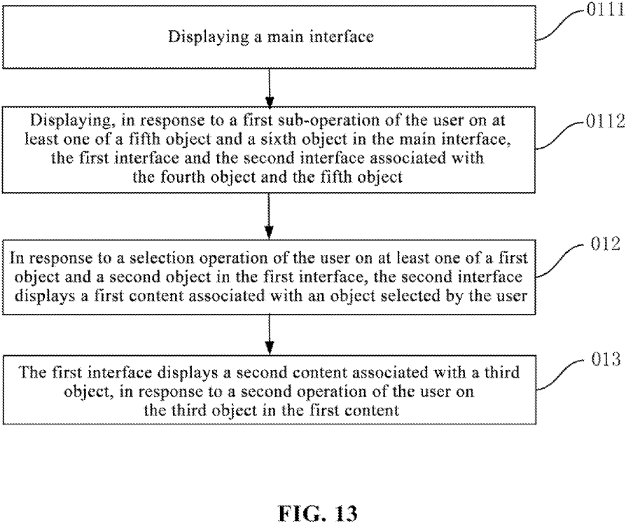

Referring to FIG. 13, in some embodiments, step 011 includes steps S0111 and step 0112.

At step 0111, a main interface is displayed.

At step 0112, in response to a first sub-operation of the user on at least one of a fifth object and a sixth object in the main interface, the first interface 311 and the second interface 312, which is associated with the fourth object and the fifth object, are displayed. The first interface 311 is at least a part of the main interface.

Referring again to FIG. 2, in some embodiments, the first control module 11 is further configured to execute step 0111 and step 0112. That is, the first control module 11 is further configured to control display of the main interface, and control, in response to a first sub-operation of the user on at least one of the fifth object and the sixth object in the main interface, the first interface 311 and the second interface 312, which is associated with the fourth object and the fifth object, to display. The first interface 311 is at least a part of the main interface.

Referring again to FIG. 3, in some embodiments, the processor 20 is further configured to control the display of the main interface; and to control the first interface 311, and the second interface 312 associated with the fourth object and the fifth object to display in response to the first sub-operation of the user on at least one of the fifth object and the sixth object in the main interface. The first interface 311 is at least a part of the main interface. That is, step 0111 and step 0112 may be implemented by processor 20.

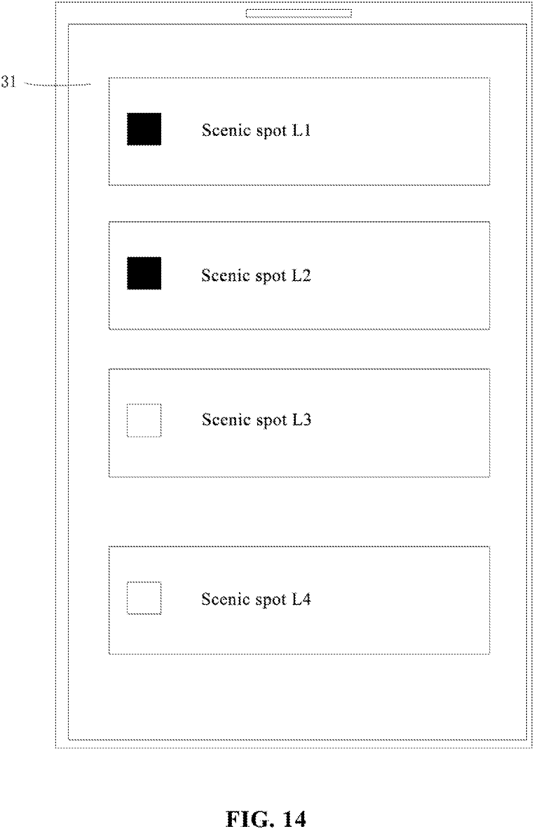

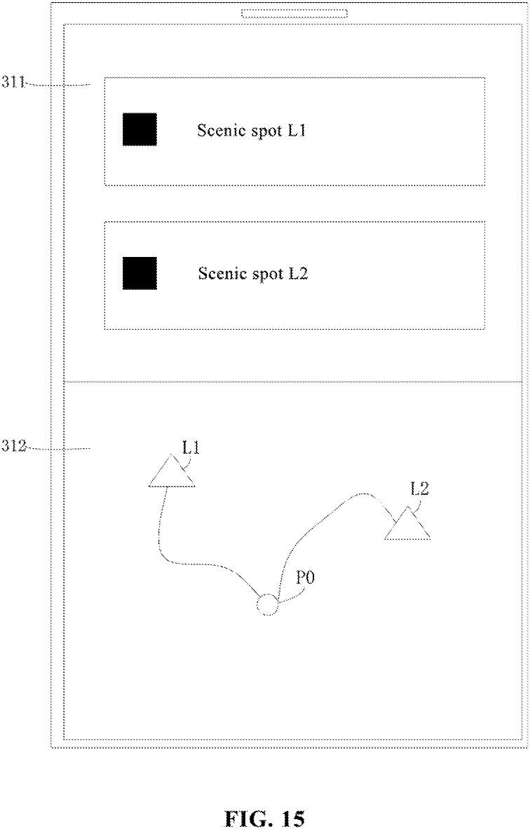

Exemplarily, referring to FIG. 14 and FIG. 15, the display 30 does not perform the split screen interaction operation in the initial state, and at this time the display interface 31 displays the main interface. For example, the main interface may be a desktop of a mobile phone, an interface of an application, and the like. Taking a case in which the main interface is a scenic spot interface showing nearby scenic spots in Dianping as an example, the scenic spot interface shows a plurality of scenic spot objects, and the processor 20 may control the first interface 311 and the second interface 312 associated with the fifth object and the sixth object to display in response to a first sub-operation of the user on at least one of the fifth object and the sixth object in the main interface. For example, the processor 20 may control the second interface 312 associated with the fifth object and the first interface 311 to display in response to the first sub-operation of the user on the fifth object in the main interface. Alternatively, the processor 20 may control the second interface 312 associated with the sixth object and the first interface 311 to display in response to the first sub-operation of the user on at least one of the sixth object in the main interface. Alternatively, the processor 20 may control the second interface 312 associated with the fifth object and the sixth object and the first interface 311 to display in response to the first sub-operation of the user on the fifth object and the sixth object in the main interface.

The fifth object and the sixth object are different objects (e.g., different objects having the same attribute or different objects having different attributes). The first interface 311 may be at least a part of the main interface. For example, the first interface 311 may be at least a part of the main interface, which means that the first interface 311 displays at least a part of the content of the main interface. For example, the first interface 311 displays all the content of the main interface. Since the first interface 311 is a smaller interface, when the first interface 311 displays all the content of the main interface, all the content of the main interface may be completely displayed only by zooming out all the content. Alternatively, the first interface 311 displays a part of the content of the main interface, and at this time the part of the content of the main interface may be completely displayed without zooming out the part of the content.

Exemplarily, the first sub-operation of the user on the fifth object and the sixth object in the main interface may be the selection operation of the user on the fifth object and the sixth object. For example, both of the fifth object and the sixth object are scenic spot objects (e.g., the scenic spot L1 and the scenic spot L2 in FIG. 14, respectively), a selection box corresponding to the scenic spot object is clicked to complete the selection operation, and then a split screen interaction operation is performed, such as a split screen interaction gesture is drawn. The processor 20 controls the display interface 31 to display the first interface 311 and the second interface 312 according to the selection operation and the split screen interaction gesture, wherein the first interface 311 displays at least a part of the content of the main interface (e.g., information about the selected object, that is, information on the scenic spot L1 and the scenic spot L2), and the second interface 312 displays information associated with the fifth object and the sixth object. The second interface 312 may be a navigation interface of a map, or an interface of a tourist-type application. Taking the second interface 312 as a navigation interface of a map as an example, the second interface 312 displays a navigation interface containing navigation routes from the current location P0 of the user to the scenic spot L1 and the scenic spot L2. It should be noted that the fifth object and the sixth object are only used for convenience of description, and the main interface is not limited to include only two objects.

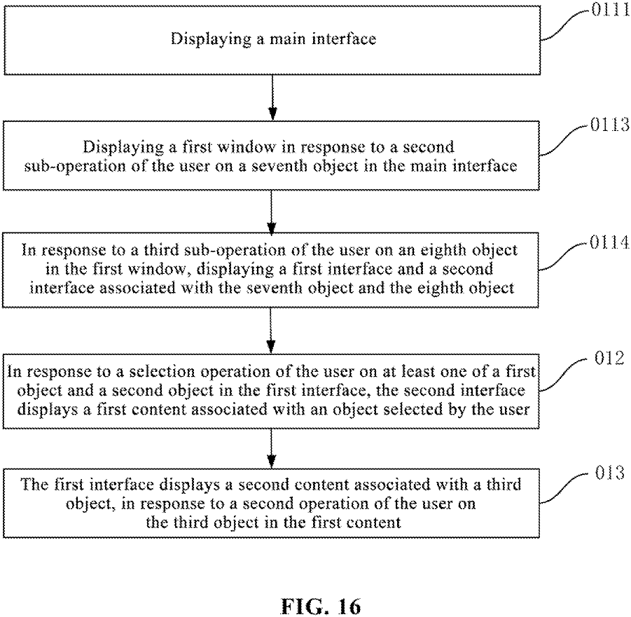

Referring to FIG. 16, in some embodiments, step 011 includes steps 0111, 0113 and 0114.

At step 0111, a main interface is displayed.

At step 0113, a first window is displayed in response to a second sub-operation of the user on a seventh object in the main interface, wherein the first window is a floating window displayed on the main interface.

At step 0114, in response to a third sub-operation of the user on an eighth object in the first window, a first interface 311 and a second interface 312, which is associated with the seventh object and the eighth object, are displayed, wherein the first interface 311 is at least a part of the main interface.

Referring to FIG. 2 again, in some embodiments, the first control module 11 is further configured to execute step 0111, step 0113, and step 0114. That is, the first control module 11 is further configured to control display of the main interface; and to control display of a first window in response to a second sub-operation of the user on a seventh object of the main interface, wherein the first window is a floating window displayed on the main interface; and to control the first interface 311, and the second interface 312 associated with the seventh object and the eighth object to display, in response to a third sub-operation of the user on the eighth object in the first window, wherein the first interface 311 is at least a part of the main interface.

Referring again to FIG. 3, in some embodiments, the processor 20 is further configured to control the display of the main interface; control display of a first window in response to a second sub-operation of the user on a seventh object of the main interface, and wherein the first window is a floating window displayed on the main interface; and control a first interface 311, and a second interface 312 associated with the seventh object and the eighth object to display, in response to a third sub-operation of the user on the eighth object in the first window, wherein the first interface 311 is at least a part of the main interface. That is, step 0111, step 0113, and step 0114 may be implemented by processor 20.

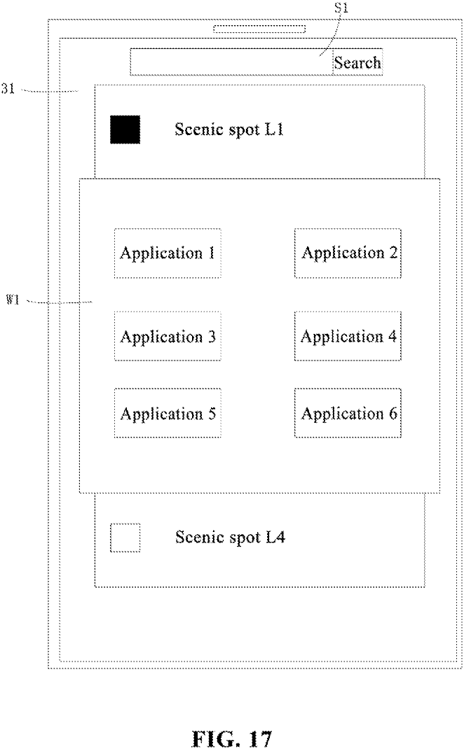

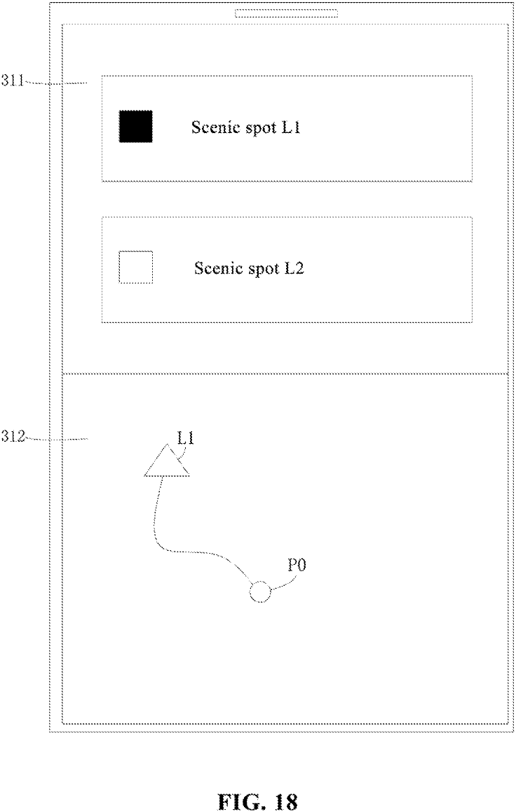

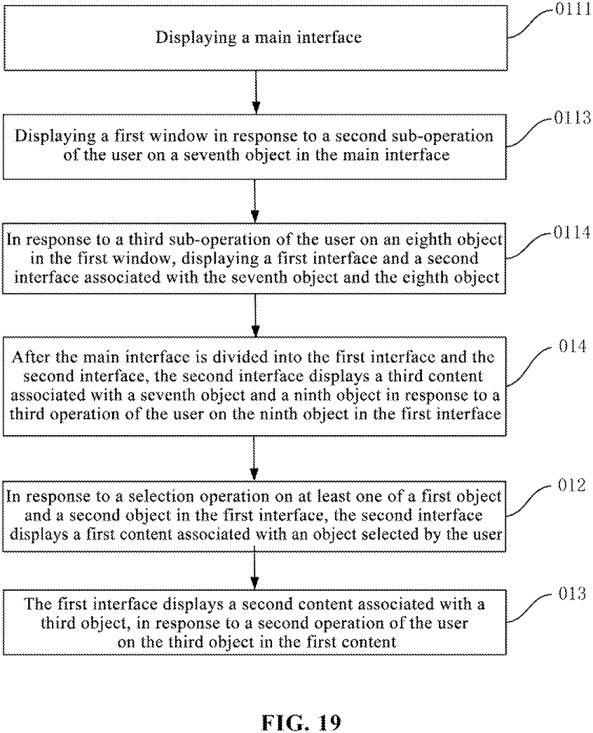

Exemplarily, referring to FIG. 17 and FIG. 18, the display 30 does not perform the split screen interaction operation in the initial state, and at this time the display interface 31 displays a main interface. For example, the main interface may be a desktop of a mobile phone, an interface of an application, and the like. Taking a case in which the main interface is an interface showing nearby scenic spots in Dianping as an example, the processor 20 may control the first interface 311, and the second interface 312 associated with the seventh object to display in response to a first sub-operation on the user’s seventh object in the main interface. The first interface 311 may be at least a part of the main interface, for example, the first interface 311 may be at least a part of the main interface, which means that the first interface 311 displays at least a part of the contents of the main interface. For example, the first interface 311 displays all the contents in the main interface, alternatively, the first interface 311 displays a part of all the contents in the main interface.

Exemplarily, the second sub-operation of the user on the seventh object of the main interface may be a click operation, a long-press operation, or an input operation performed by the user on the seventh object. For example, the seventh object is a scenic spot object (e.g., the scenic spot L1 in FIG. 17). A selection box corresponding to the scenic spot L1 is clicked to complete the click operation, a long-press operation is performed on the scenic spot L1 to complete the long-press operation. Alternatively, the seventh object is a search box S1 in the main interface and the user inputs information through the search box S1 to complete the input operation. The processor 20 controls the main interface to display the first window W1 according to the click operation, the long-press operation, or the input operation, where the first window W1 may be a floating window displayed on the main interface. The first window W1 may also be the second interface 312 obtained after the processor 20 performs the split screen display according to the click operation. An eighth object (one of the applications 1 to 6 as shown in FIG. 17) associated with the seventh object is displayed in the first window W1. When the first window W1 is displayed according to the click operation or the long-press operation, the eighth object is associated with the seventh object. When the first window W1 is displayed according to the input operation, the eighth object is associated with the input information received through the seventh object. For example, in a case where the input information of the user is “gourmet food”, the associated eighth object is typically a recipe type application, a takeaway type application, or the like.

The processor 20 determines that the user selects the eighth object, in response to a third sub-operation (e.g., a click operation) of the user on the eighth object, and then controls the display interface 31 to display the first interface 311 and the second interface 312, wherein the first interface 311 displays at least a part of the display content of the main interface (e.g., the information on the selected object, such as information of the scenic spot L1), and the second interface 312 is associated with the seventh object and the eighth object. For example, the eighth object may be a map application or a tourist-type application. Taking the eighth object being a map as an example, and the second interface 312 is a navigation interface including a navigation route from the current location P0 of the user to the scenic spot L1.

Referring to FIG. 19, in some embodiments, the split screen interaction method further includes step 014.

At step 014, after the main interface is divided into the first interface 311 and the second interface 312, the second interface 312 displays a third content associated with a seventh object and a ninth object in response to a third operation of the user on the ninth object in the first interface 311, wherein the ninth object is different from the seventh obj ect.

Referring again to FIG. 2, in some embodiments, the split screen interaction device 10 further includes a fourth control module 14. The fourth control module 14 is configured to execute step 014. That is, the fourth control module 14 is configured to, after the main interface is divided into the first interface 311 and the second interface 312, control the second interface 312 to display a third content associated with a seventh object and a ninth object in response to the third operation of the user on the ninth object in the first interface 311, wherein the ninth object is different from the seventh obj ect.

Referring again to FIG. 3, in some embodiments, the processor 20 is further configured to, after the main interface is divided into the first interface 311 and the second interface 312, control the second interface 312 to display a third content associated with a seventh object and a ninth object, in response to the third operation of the user on the ninth object in the first interface 311, wherein the ninth object and the seventh object are different objects. That is, step 014 may be implemented by processor 20.

Exemplarily, referring to FIG. 15 again, after the main interface is divided into the first interface 311 and the second interface 312, the second interface 312 displays a third content associated with a seventh object and a ninth object in response to the third operation of the user on the ninth object in the first interface 311, wherein the seventh object and the ninth object are different objects. For example, the second interface 312 after the split screen operation displays the navigation route from the current location P0 of the user to the seventh object (e.g. the scenic spot L1). In a case where the user wants to view the navigation route to the ninth object (e.g. the scenic spot L2), at this time the user only needs to perform a third operation, such as a click operation, on the ninth object, so that the processor 20 determines that the second interface 312 is displaying now in response to the click operation, and directly controls the second interface 312 to synchronously display the navigation routes from the current location P0 of the user to the seventh object and to the ninth object (i.e., the third content is an navigation interface displaying the navigation routes from the current location P0 of the user to the seventh object and the ninth object, respectively), without displaying the first window W1 again to perform the split screen operation according to the third sub-operation of the user on the eighth object associated with the ninth object.

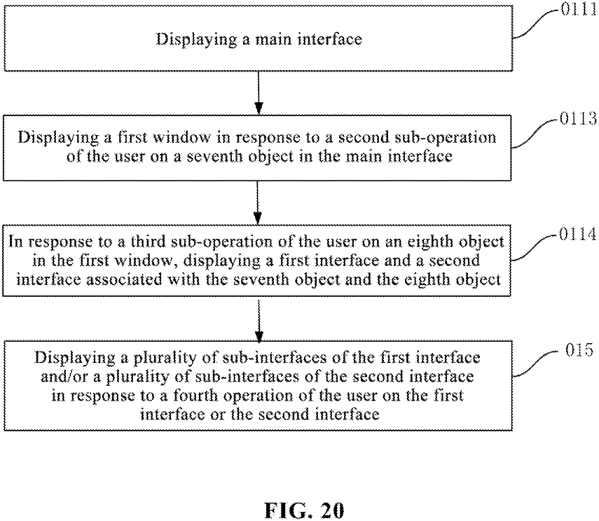

Referring to FIG. 20, in some embodiments, the split screen interaction method further includes step 015.

At step 015, a plurality of sub-interfaces of the first interface 311 and/or a plurality of sub-interfaces of the second interface 312 are displayed in response to a fourth operation of the user on the first interface 311 or the second interface 312.

Referring again to FIG. 2, in some embodiments, the split screen interaction device 10 further includes a fifth control module 15. The fifth control module 15 is configured to execute step 015. That is, the fifth control module 15 is configured to control display of a plurality of sub-interfaces of the first interface 311 and/or control display of a plurality of sub-interfaces of the second interface 312, in response to the fourth operation of the user on the first interface 311 or the second interface 312.

Referring again to FIG. 3, in some embodiments, the processor 20 is further configured to control display of a plurality of sub-interfaces of the first interface 311 and/or control display of a plurality of sub-interfaces of the second interface 312, in response to a fourth operation of the user on the first interface 311 or the second interface 312. That is, step 015 may be implemented by processor 20.

Exemplarily, after the main interface is divided into the first interface 311 and the second interface 312, in order to adapt to more diversified split screen experience, the processor 20 may control the first interface 311 to display a plurality of sub-interfaces and/or control the second interface 312 to display a plurality of sub-interfaces in response to a fourth operation of the user on the first interface 311 or the second interface 312.

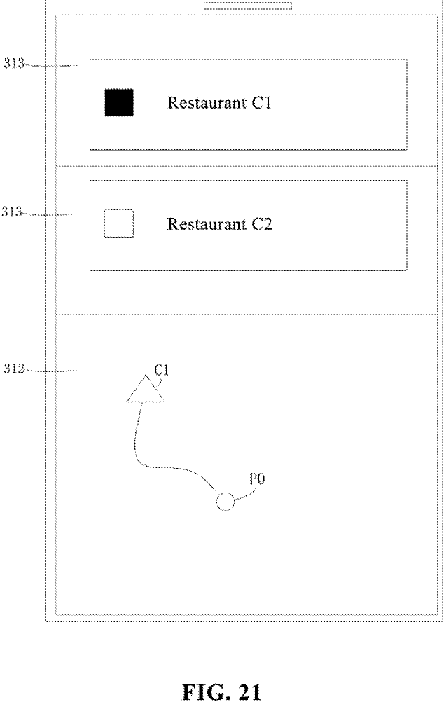

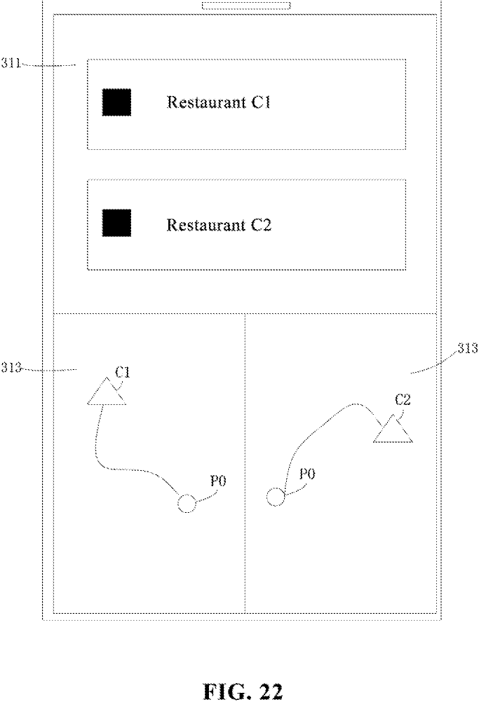

Referring to FIG. 21 and FIG. 22, for example, when the user performs a fourth operation (such as a split screen interaction operation) on the first interface 311, the processor 20 performs the split screen interaction again on the first interface 311 to display a plurality of sub-interfaces 313; or the processor 20 performs the split screen interaction again on the second interface 312 to display a plurality of sub-interfaces 313; therefore, the split screen interaction is performed on the first interface 311 or the second interface 312 again through the fourth operation on the first interface 311. For another example, when the user performs a fourth operation (such as the split screen interaction operation) on the second interface 312, the processor 20 performs the split screen interaction operation again on the first interface 311 to display a plurality of sub-interfaces 313; or the processor 20 performs the split screen interaction operation on the second interface 312 to display a plurality of sub-interfaces 313. Therefore, the split screen interaction operation is performed on the first interface 311 or the second interface 312 again through the fourth operation on the second interface 312. A direction along which the screen is split is a long side direction (as shown in FIG. 21) or a short side direction (as shown in FIG. 22) of the mobile phone.

For another example, when the user performs a fourth operation (e.g., a selection operation) on a tenth object in the first interface 311, the processor 20 performs the split screen interaction operation on the second interface 312 again to display a plurality of sub-interfaces 313, where each of the sub-interfaces 313 displays a content corresponding to a selected object. For example, the first interface 311 is an interface displaying nearby restaurants in Dianping, and the second interface 312 is a navigation interface of a map. After the user selects the seventh object (e.g., the restaurant C1) for split screen display and displays a navigation interface corresponding to the seventh object, the user further selects the tenth object (e.g., the restaurant C2), at this time the processor 20 controls the second interface 312 to be divided into two sub-interfaces 313 so as to display routes from the current location P0 of the user to the restaurant C1 and the restaurant C2, respectively. Therefore, the split screen interaction operation is carried out on each of the selected objects, so that the user can view more information at the same time, and the user can operate each of the sub-interfaces 313 independently to conveniently view the specific information about the restaurant that the user is interested in after clicking the restaurant. Similarly, when the user performs a fourth operation (e.g., a selection operation) on an object in the second interface 312, the processor 20 may also perform the split screen interaction operation on the first interface 311 again to display a plurality of sub-interfaces 313, where each of the sub-interfaces 313 displays a content corresponding to a selected object.

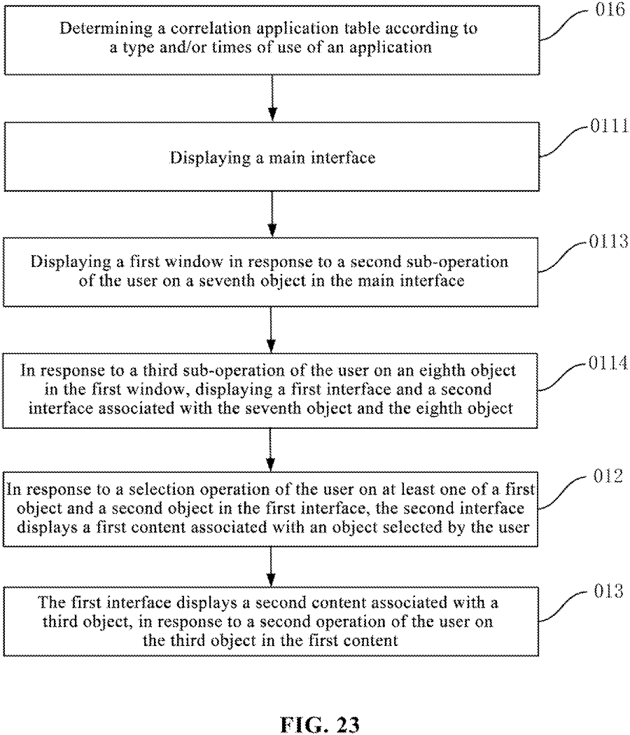

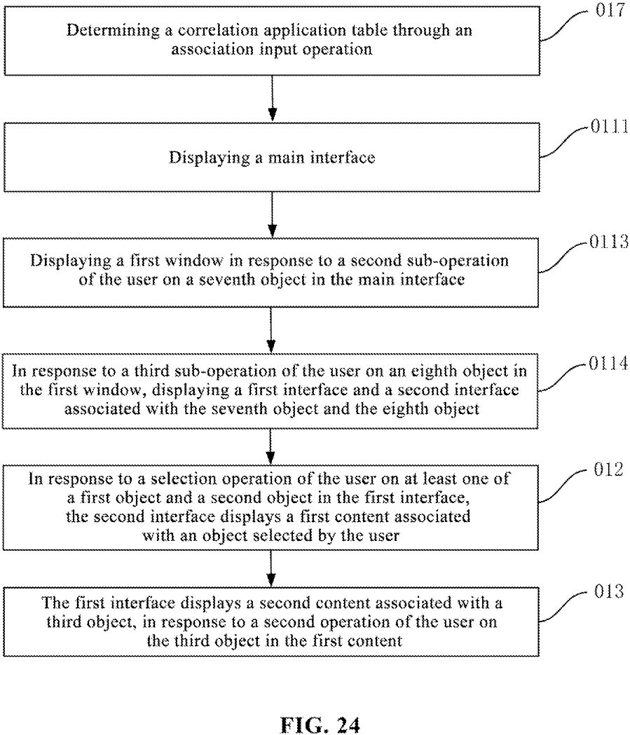

Referring to FIGS. 23 and 24, in some embodiments, the split screen interaction method further includes step 016 and step 017.

At step 016, a correlation application table is determined according to a type and/or times (or the number of times) of use of an application; and/or

At step 017, a correlation application table is determined by performing an association input operation.

Referring again to FIG. 2, in some embodiments, the split screen interaction device 10 includes a first determination module 16 and a second determination module 17. The first determination module 16 and the second determination module 17 execute step 016 and step 017, respectively. That is, the first determination module 16 is configured to determine the correlation application table according to the type and/or times of use of the application, and the second determination module 17 is configured to determine a correlation application table by receiving an association input operation.

Referring again to FIG. 3, in some embodiments, the processor 20 is further configured to determine a correlation application table based on the type and/or number of uses of an application, and/or to determine a correlation application table by receiving an association input operation.

Exemplarily, the processor 20 may determine or update the correlation application table according to the type and times of use of an application. For example, a gourmet good application may be associated with a recipe application, and a map application may be associated with a lifestyle application, and the like. When a current application is associated with too many applications, the processor 20 may determine, according to times of use of an application associated with the current application, whether to associate the application with the current application. For example, there are multiple applications (e.g., five or six applications, etc.) associated with the current application based on the type of application, but one of the multiple applications is not used substantially (e.g., used once a month, once a half year, etc.), and then the application may be considered an application that is not associated with the current application. The times of use may be the number of times of using the application by the user; alternatively, the number of times of using the application in combination with the current application by the user. Using the application in combination with the current application means that performing the split screen interaction operation by using the application and the current application. In this manner, the processor 20 determines the correlation application table based on the type and/or times of uses of the application.

The processor 20 may further receive an association input operation to establish or update an associated application table. For example, when the user perform a split screen interaction operation, the user finds that an application that the user wants to perform a split screen interaction thereon is not in the association application table, which results in that the split screen interaction operation cannot be performed on the application. In this case, the user may actively perform the association input operation in a setting interface to manually add an application associated with the current application. For example, in a setting interface for Dianping, a map application, a takeaway application, a travel application, and the like may be added as the associated applications for Dianping, so as to establish or update the correlation application table, thereby facilitating the subsequent split screen interaction operation on the applications. Therefore, when the split screen interaction operation is performed, the associated application(s) associated with the current object is displayed through the correlation application table. For example, when the first window W1 displays the eighth object associated with the seventh object (as shown in FIG. 17), the application (i.e., the eighth object) associated with the seventh object may be determined and displayed according to the application corresponding to the seventh object and the correlation application table.

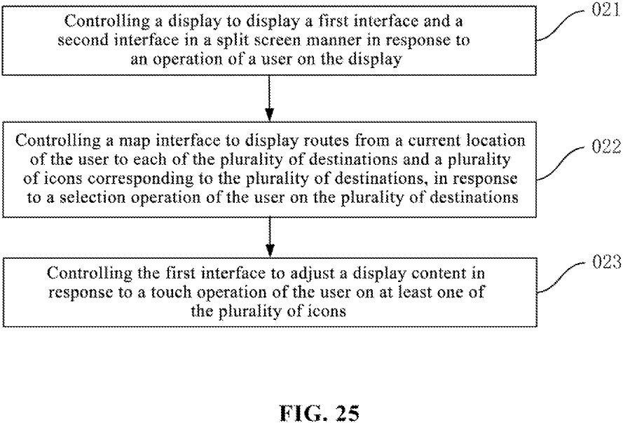

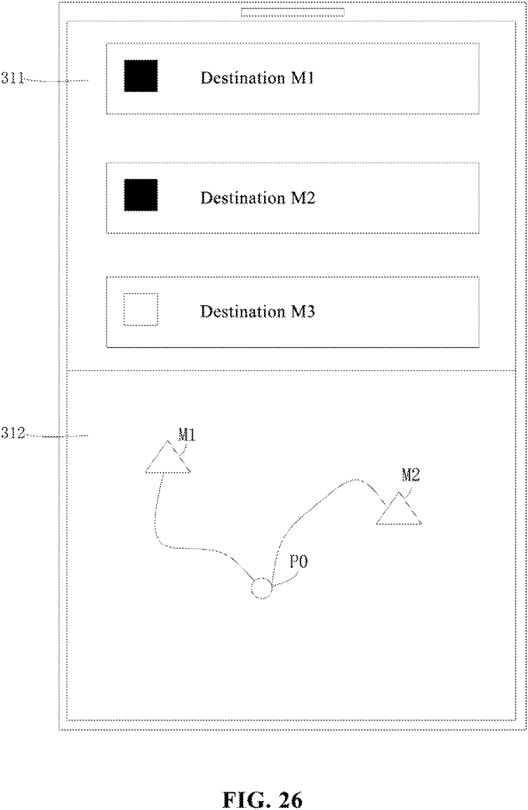

Referring to FIGS. 25 and 26, a split screen interaction method for a terminal 1000 according to another embodiment of the present disclosure includes step 021 to step 023.

At step 021, the display 30 displays a first interface 311 and a second interface 312 in a split screen manner in response to an operation of a user on the display 30, wherein the first interface 311 displays a list of a plurality of destinations, and the second interface 312 displays a map interface.

At step 022, the map interface displays routes from the current location P0 of the user to each of the plurality of destinations and a plurality of icons corresponding to the plurality of destinations, in response to a selection operation of the user on the plurality of destinations.

At step 023, the first interface 311 adjusts a display content in response to a touch operation of the user on at least one of the plurality of icons.

Referring again to FIG. 2, the first control module 11 is further configured to execute step 021, the second control module 12 is further configured to execute step 022, and the third control module 13 is further configured to execute step 023. That is, the first control module 11 is configured to control the display 30 to display a first interface 311 and a second interface 312 in a split screen manner in response to an operation of a user on the display 30, wherein the first interface 311 displays a list of a plurality of destinations, and the second interface 312 displays a map interface. The second control module 12 is configured to control the map interface to display routes from the current location P0 of the user to each of the plurality of destinations and a plurality of icons corresponding to the plurality of destinations in response to a selection operation of the user on the plurality of destinations. The third control module 13 is configured to control the first interface 311 to adjust the display content in response to a touch operation of the user on at least one of the plurality of icons.

Referring again to FIG. 3, the processor 20 is further configured to control the display 30 to display a first interface 311 and a second interface 312 in a split screen manner in response to an operation of a user on the display 30, wherein the first interface 311 displays a list of a plurality of destinations, and the second interface 312 displays a map interface; to control the map interface to display routes from the current location P0 of the user to each of the plurality of destinations and a plurality of icons corresponding to the plurality of destinations in response to a selection operation of the user on the plurality of destinations; and to control the first interface 311 to adjust the display content in response to a touch operation of the user on at least one of the plurality of icons.

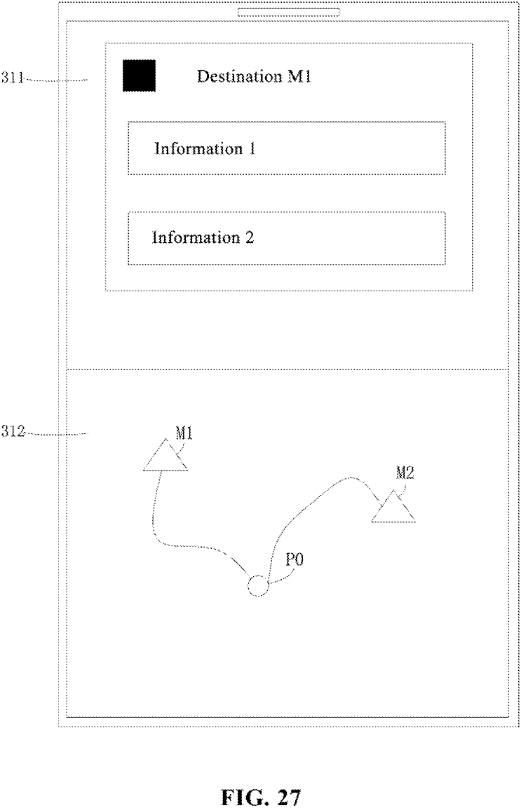

Exemplarily, referring to FIG. 26 and FIG. 27, the processor 20 controls the display 30 to display a first interface 311 and a second interface 312 in a split screen interaction manner, in response to an operation of a user on the display 30 (e.g., a split screen interaction operation may be performed by drawing a split screen interaction gesture or by clicking a preset split screen button). The first interface 311 displays a list of a plurality of destinations. The user may select a destination, for example, by clicking a selection box corresponding to the destination, so as to complete the selection operation. The destination may be any object, such as a restaurant, a cinema, a mall, or a scenic spot. The second interface 312 displays a map interface. The processor 20 controls, in response to a selection operation of the user on a destination, the map interface to display a route from the current location P0 of the user to the selected destination and an icon corresponding to the selected destination. For example, in a case where the destination M1 and the destination M2 as shown in FIG. 26 are selected, the routes from the current location P0 of the user to the destination M1 and the destination M2 respectively and the icons of the destination M1 and the destination M2 are displayed in the map interface, so that the routes are directly displayed in the map interface according to the selection of the user without searching for the destination to obtain a navigation route after the user independently opens a map application. Meanwhile, the user may select a desired destination from the plurality of destinations according to the route information displayed on the map, thereby improving the convenience of the user operation and further improving the user experience. The processor 20 may further control the first interface 311 to adjust the display content thereof in response to a touch operation of the user on an icon corresponding to the destination in the map interface. Exemplarily, controlling the first interface 311 to adjust the display content thereof may include controlling the first interface to display information about the destination corresponding to the icon selected by the user. For example, when the user clicks on an icon of the destination M1, the first interface 311 correspondingly displays information about the destination M1 (such as the information 1 and the information 2 in FIG. 26), instead of displaying only a list of destinations, so as to form an interactive display of the first interface 311 and the second interface 312, thereby obtaining a better experience.

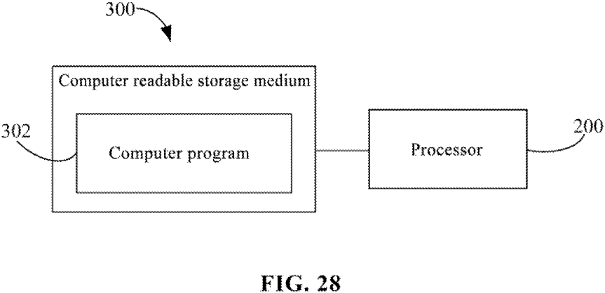

Referring to FIG. 28, a non-transitory computer-readable storage medium 300 storing a computer program 302 according to an embodiment of the present disclosure is provided. When the computer program 302 is executed by one or more processors 200, the one or more processors 200 may execute the split screen interaction method according to any of the above embodiments.

For example, referring to FIG. 1, the computer program 302, when executed by the one or more processors 200, causes the one or more processors 200 to perform the following steps 011 and 012.

Step 011: control a first interface and a second interface to display in response to a first operation of a user; and

Step 012: control, in response to a selection operation of the user on at least one of a first object and a second object in the first interface, the second interface to display a first content associated with an object selected by the user.

For another example, referring to FIG. 8, the computer program 302, when executed by the one or more processors 200, further causes the one or more processors 200 to perform the following step 013.

Step 013: control the first interface 311 to display a second content associated with a third object, in response to a second operation of the user on the third object in the first content.

For another example, referring to FIG. 13, the computer program 302, when executed by the one or more processors 200, further causes the one or more processors 200 to perform the following step 0111 and 0112.

Step 0111: control display of a main interface; and

Step 0112: control the first interface 311, and a second interface 312 associated with a fourth object and a fifth object to display in response to a first sub-operation of the user on the fifth object and the sixth object in the main interface, wherein the first interface 311 is at least a part of the main interface.

In the description of the present specification, reference to the description of “an embodiment”, “some embodiments”, “illustrative embodiments”, “examples”, “specific examples” or “some examples” or the like means that a particular feature, structure, material, or characteristic described in connection with the embodiment or the example is included in at least one of the embodiments or examples of the present disclosure. In the specification, schematic representations of the above terms do not necessarily refer to the same embodiment or example. Furthermore, the particular feature, structure, material, or characteristic described may be combined in any suitable manner in any one or more embodiments or examples. Moreover, various embodiments or examples and features in the various embodiments or examples described in the specification can be combined and combined by those skilled in the art without being mutually inconsistent.

Any process or method descriptions in flow charts or otherwise described herein may be understood as representing a module, a segment, or a part of a code of a program including steps for implementing specific logical functions or process, and alternate implementations are within the scope of the preferred embodiment of the present disclosure; in the alternate implementations, the functions may be executed out of order from that shown or discussed, but the functions may be executed out according to the involved functions in a basically simultaneous manner or in reverse order, as would be understood by those skilled in the art of the present disclosure.

Although the embodiments of the present disclosure have been shown and described above, it should be understood that the above embodiments are exemplary and are not limitations to the present disclosure, and variations, modifications, substitutions and alterations of the embodiments may be made by those skilled in the art within the scope of the present disclosure.

1. An interaction method for a terminal, wherein the terminal comprises a display, and the interaction method comprises:
controlling the display to display a first interface and a second interface in a split screen mode in response to an operation of a user on the display, wherein the first interface displays a list of a plurality of destinations, and the second interface displays a map interface;
controlling the map interface to display routes from a current location of the user to each of the plurality of destinations respectively and a plurality of icons corresponding to the plurality of destinations in response to a selection operation of the user on the plurality of destinations; and
controlling the first interface to adjust a display content in response to a touch operation of the user on at least one of the plurality of icons.

2. The interaction method of claim 1, wherein
controlling the first interface to adjust the display content comprises: controlling the first interface to display information associated with a destination corresponding to an icon selected by the user.

3. An interaction method, comprising:
displaying a first interface and a second interface in response to a first operation of a user; and
controlling, in response to a selection operation of the user on at least one of a first object and a second object in the first interface, the second interface to display a first content associated with an object selected by the user.

4. The interaction method of claim 3, wherein the first object and the second object have a same attribute.

5. The interaction method of claim 3, wherein
controlling, in response to a selection operation of the user on at least one of a first object and a second object in the first interface, the second interface to display a first content associated with an object selected by the user comprises: controlling the second interface to display the first content associated with the first object and the second object selected by the user in response to a selection operation of the user on the first object and the second object in the first interface.

6. The interaction method of claim 3, wherein
the first interface and the second interface are different interfaces of different applications, respectively, or
the first interface and the second interface are different interfaces of different function modules of a same application.

7. The interaction method of claim 3, further comprising:
controlling, in response to a second operation of the user on a third object in the first content, the first interface to display a second content associated with the third object.

8. The interaction method of claim 7, wherein the second operation of the user on the third object in the first content comprises an operation of determining, by the user, a first region containing the third object in the second interface.

9. The interaction method of claim 8, wherein
a range of the first region is determined according to a touch track of the user; or
a range of the first region is determined according to range information input by the user.

10. The interaction method of claim 8, wherein controlling the first interface to display the second content associated with the third object comprises:
controlling the second interface to display a fourth object in response to the operation of determining, by the user, the first region containing the third object in the second interface, wherein the fourth object is located in the first region, and
controlling the first interface to display the second content associated with the third object and the fourth object.

11. The interaction method of claim 3, wherein displaying the first interface and the second interface in response to the first operation of the user comprises:
displaying a main interface, and
displaying, in response to a first sub-operation of the user on at least one of a fifth object and a sixth object in the main interface, the first interface and the second interface, the second interface being associated with the fifth object and the sixth object, wherein the first interface is at least a part of the main interface.

12. The interaction method of claim 3, wherein displaying the first interface and the second interface in response to the first operation of the user comprises:
displaying a main interface,
displaying a first window in response to a second sub-operation of the user on a seventh object in the main interface, wherein the first window is a floating window displayed on the main interface, and
displaying, in response to a third sub-operation of the user on an eighth object in the first window, the first interface and the second interface, the second interface being associated with the seventh object and the eighth object, wherein the first interface is at least a part of the main interface.

13. The interaction method of claim 12, wherein the second sub-operation of the user on the seventh object in the main interface comprises one of a click operation, a long-press operation, or an input operation of the user on the seventh object in the main interface.

14. The interaction method of claim 12, further comprising:
after the main interface is divided into the first interface and the second interface, controlling, in response to a third operation of the user on a ninth object in the first interface, the second interface to display a third content associated with the seventh object and the ninth object, wherein the ninth object is different from the seventh object.

15. The interaction method of claim 3, further comprising:
in response to a fourth operation of the user on the first interface or the second interface, controlling the first interface to display a plurality of sub-interfaces and/or controlling the second interface to display a plurality of sub-interfaces.

16. The interaction method of claim 3, further comprising:
determining a correlation application table according to a type and/or times of use of an application; and/or
determining a correlation application table by performing an association input operation.

17. The interaction method of claim 3, wherein
the first object is a restaurant object, the second object is a cinema object, the second interface is a map interface, and
controlling, in response to the selection operation of the user on at least one of the first object and the second object in the first interface, the second interface to display the first content associated with the object selected by the user comprises: controlling, in response to a selection operation of the user on at least one of the restaurant object and the cinema object, the second interface to display a route from a current location of the user to the selected object and an icon corresponding to the selected object.

18. An interaction device, comprising: a processor and a memory having instructions stored thereon which, when being executed by the processor, cause the processor to perform the interaction method of claim 1.

19. An electronic apparatus comprising a processor and a display, wherein the processor is configured to:
control the display to display a first interface and a second interface in response to a first operation of a user, and
control, in response to a selection operation of the user on at least one of a first object and a second object in the first interface, the second interface to display a first content associated with an object selected by the user.

20. A non-transitory computer-readable storage medium storing instructions which, when executed by a processor, cause the processor to perform the interaction method of claim 1.
